(19) United States
(12) Patent Application Publication
(10) Pub. No.: US 2005/0050756 A1
(43) Pub. Date: Mar. 10, 2005

(54) Drying apparatus, system and kit

(76) Inventor: Anthony Casella, Cushing, ME (US)

Correspondence Address: Lawson & Persson, P.C.;Suite 103, 67 Water Street, Laconia, NH, 03246, US

(21) Appl. No.: 10/935,416

(22) Filed: Sep. 7, 2004

Related U.S. Application Data
(60) Provisional application No. 60/500,916, filed on Sep. 8, 2003.

(51) Int. Cl. F26B 19/00

(52) U.S. Cl. 34/218

(57) ABSTRACT

A drying apparatus, system and kit. The apparatus includes a housing defining an air intake and air exhaust and at least one fan disposed within the housing and positioned to create a flow of air from the air intake to the air exhaust. A heater is disposed within the housing and positioned to heat the flow of air directed from the air intake to the air exhaust while a control means is provided for controlling an operation of at least one of the at least one fan and the heater. Attachment means is provided for removably attaching the housing to a garment enclosure. The system and kit each include at least one garment enclosure to which the apparatus is attached.

### CLAIM OF PRIORITY

This application claims the benefit of U.S. Provisional Patent Application Ser. No. 60/500,916 filed on Sep. 8, 2003.

### FIELD OF THE INVENTION

The present invention relates to the field of portable clothes drying devices and, in particular, to a device and method for drying and de-wrinkling articles of clothing without tumbling by utilizing a flow of air.

### BACKGROUND OF THE INVENTION

Conventional wet washing and tumble-drying machines are effective at cleaning and drying clothing, and are readily available, and affordable, to individuals and small businesses. However, conventional tumble-drying typically results in dried clothes that are wrinkled and, therefore, not suitable for wear without de-wrinkling via ironing, steaming, or other art recognized means. Further, conventional means are typically heavy floor mounted units that must be vented and operate on 220 VAC power, preventing them from being used when a person is outside of the home.

A number of non-tumble type dryers have been developed and patented. However, each of these fails to solve the problems of lack of portability and lack of ability to dewrinkle clothes that have been identified by the inventor of the present invention.

For example, U.S. Pat. No. 5,555,640, titled “Household Drying Center”, discloses a multipurpose household drying center in which a blower and heating chamber are disposed on the top portion of a cabinet to generate forced and heated air downward into a drying chamber in the cabinet below the heating chamber.

There are horizontally disposed heat diffusion plates under the heating chamber and vertically disposed air ducts on the side walls of the cabinet to enable heated air to be evenly distributed and filled in the drying chamber for uniform drying of the goods held therein. A support stand having a horizontal and rectangular frame secured on the top ends of a pair of spaced and vertical telescopically structured tubes is disposed within the drying chamber for hanging clothes, and can support a wire basket for holding delicate or odd shape goods for drying. There are side rods on the sidewalls for hanging articles, and a base grid is provided above the bottom wall to hold heavy or odd shape goods for drying.

The above referenced patent states “clothes and goods are dried without tumbling, thus avoiding fraying or wrinkles.” However, this is not the case as the drying center fails to dry clothes with air coming from the top direction in a straight downward manner through a direct vent in the bottom of the unit to force the water in the clothes downward to act as a weight while drying to remove wrinkles. It also relies on heat and not air to dry clothes. It is not portable by any means and needs to be vented, and also uses standard 220 volts and not 110 volts to operate.

U.S. Pat. No. 4,682,424, titled “Clothes Drying Apparatus”, describes yet another non-tumble style drying apparatus that includes a hanger rod mounted above a drip pan element, that may be removed from a drying cabinet so that wet clothing articles may be easily mounted on the hanger rod. The patent discloses a system that is similar to that disclosed in U.S. Pat. No. 5,555,640, and further includes an automatic control so that the drying cycle may be pre-selected so as to achieve the most efficient drying of the clothing articles. However, this apparatus also has distinct drawbacks that make it unsuited to satisfactorily solving the problems solved by the present invention. For example, like the dryer of U.S. Pat. No. 5,555,640, this apparatus fails to monitor and adjust the air for temperature and humidity, which are the primary factors in reducing wrinkles. Further, it likewise requires that that same hot air be utilized for drying, creating a risk of damage to the clothing being dried and the risk of bums to users.

However, this drying center also fails to dry clothes with air coming from the top direction in a straight downward manner through a direct vent in the bottom of the unit to force the water in the clothes downward to act as a weight while drying to remove wrinkles. It also relies on heat and not air to dry clothes. It is not portable by any means and needs to be vented and uses standard 220 volts and not 110 volts to operate

Another non-tumble dryer is disclosed in U.S. Pat. No. 5,815,961, titled “Clothes Treating Cabinet with Inflatable Hanger”. This patent discloses clothes treating apparatus having a cabinet that defines an interior region for receiving clothes. The interior region has opposed inner side surfaces and a door is connected to the cabinet for closing the interior region. An inflatable hanger for supporting shirt-like clothes items is disposed within the interior region and is in communication with a blower that selectively inflates the inflatable hanger for pressing the shirt-like clothes item against the cabinet inner side surfaces. A steam generation means is provided for introducing moist air into the cabinet for humidifying the clothes item disposed therein. A heater and fan supply heated air into the interior region for drying the shirt-like clothes items disposed therein. During the de-wrinkling cycle, steam is introduced into the interior region while the inflatable hanger assembly is periodically inflated. Following the steaming period, the inflatable hanger is inflated while the clothes are subject to warm air such that the clothes wrinkles are pressed out and the clothes are partially dried, setting the clothes in a smooth appearance. Heated air is then delivered into the interior region to completely dry the clothes item.

This system claims to be effective at de-wrinkling already dried clothes, but has inherent drawbacks. The first, and foremost, of these drawbacks is the need to carefully arrange the clothing and inflatable hanger to avoid any unwanted creasing of the garment. If the hanger and clothing are not properly arranged, the inflation of the hanger will cause the garment to fold upon itself and cause a crease or wrinkle in an unwanted area. Another drawback is that the inflation of the hanger is unsuited for garments, such as pants or skirts that require creases to be formed in the material. Another drawback is the increased cost involved in manufacturing an inflatable hanger and the need for hangers of many sizes to accommodate the many sizes of garments. Finally, the need to generate a separate flow of steam over the garment is undesirable due to the safety hazard attendant to live steam, the need to pipe in a source of water, or continually refill a water reservoir, and the increased cost in providing means for heating and distributing the steam. Accordingly, the system described in U.S. Pat. No. 5,815,961 is not effective at solving the problem of the present invention.

In response to these drawbacks inherent in prior art clothing dryers, he inventor of the present invention developed the clothing dryer that is described and claimed in U.S. Pat. No. 6,745,496, which is incorporated herein by reference. This dryer includes a housing having an interior, made up of an upper compartment, a lower compartment, and a dividing wall separating the upper and lower compartments. The upper compartment includes a mechanical assembly that forces air downward over the clothing, while the lower compartment includes at least two vent holes of sufficient number and size, and disposed at a location within said lower compartment, to reduce the overall pressure within said lower compartment such that a volume of air is allowed to pass over the article of clothing at a sufficient velocity to force moisture held within the clothing downward towards a bottom of the article of clothing. The dryer described and claimed in this patent is effective at overcoming the drawbacks inherent it the prior art. However, the need for a housing in which the mechanical and drying portions are integrated limits the use of this dryer to home use. Accordingly, the licensee of this patent requested that the inventor design a compact and more portable clothes dryer that may be used either when traveling, or in the home. The inventor conceived of the present invention in response to this request.

Based upon the foregoing, it is apparent that there is a need for a drying apparatus and method that allows clothes to be dried quickly and without ironing or use of another appliance, that may be operated by unskilled, part-time employees, that does not require a large initial investment, a large space or the use of hazardous chemicals or live steam, that does not require piping or constant filling of a water reservoir, that effectively removes wrinkles while drying, that does not risk the creation of additional wrinkles, that does not need to be vented or to run on 220 VAC power, and that is portable and may be readily taken with a user during travel.

### SUMMARY OF THE INVENTION

The present invention is a portable device that will attach to a cabinet for home use or to a garment bag for travel drying, this apparatus, system and kit overcome the drawbacks inherent in the prior art by removing most wrinkles from clothes and drying them in a single appliance using a controlled flow of air through a small space without a conventional tumble drum.

The drying apparatus of the present invention utilizes forced air to dry clothes without tumbling them. A wind-tunnel effect, combined with the process of drying fabric from the top down create a new way to dry clothes that is superior to that in the industry today. The dryer of the present invention effectively dries and de-wrinkles clothing by passing a volume of high velocity air downward onto the article of clothing, which tends to move the water from the top of the article of clothing downward. The congregation of this water at the bottom of the article acts as a weight and places the article in tension, effectively preventing the formation of most wrinkles. The inclusion the present invention effectively dries clothing using a force of warm air, or ambient temperature air, rather than the high temperature utilized in conventional dryers.

The working model size includes a housing that is dimensioned to be four inches round and twelve inches high. However, larger and smaller models based on the same process and design as the preferred embodiment have been tested and are likewise effective at solving the above mentioned problems inherent in the prior art. The preferred drying apparatus presents as a cylinder with a heating coil, fan and timer all in one compact unit. There are intake air holes on the top to allow air to flow through the unit with a single outlet hole directly on the bottom, for direct air-flow using the force of air more than heat to dry clothes.

In its most basic form, the drying apparatus includes a housing defining an air intake and air exhaust and at least one fan disposed within the housing and positioned to create a flow of air from the air intake to the air exhaust. A heater is disposed within the housing and positioned to heat the flow of air directed from the air intake to the air exhaust while a control means is provided for controlling an operation of at least one of the at least one fan and the heater. Finally, attachment means is provided for removably attaching the housing to a garment enclosure.

In the preferred embodiment of the drying apparatus, an intake fan mounted is within the housing proximate to the air intake and an exhaust fan is mounted within the housing proximate to the air exhaust. The preferred heater is an electrical-resistance heating coil and a plurality of thermally conductive fins disposed in heat conducting relation to the electrical resistance heating coil. The preferred housing has a substantially cylindrical shape and may or may not include a funnel shaped exhaust portion and that reduces the cross sectional area of the air exhaust such that it is less than that of the air intake. The preferred drying apparatus also includes a guard attached to the air intake, and it is preferred that the guard include a plurality of perforations therethrough. Some embodiments of the drying apparatus also include a hanger extending from the housing proximate to the air intake and a means for attaching a garment hanger to the apparatus.

The basic embodiment of the system for drying and dewrinkling a garment includes at least one drying apparatus and a garment enclosure having a top, a bottom, at least one mounting opening through the top and at least one bottom opening disposed proximate to the bottom.

In some embodiments of the system the garment enclosure is a substantially flexible garment bag, while in other embodiments the garment enclosure is a cabinet. In those embodiments of the system utilizing a cabinet, it is preferred that the cabinet include at least two mounting openings through the top and that two drying apparatus be mounted within the mounting openings. It is preferred that at least one of the drying apparatus be removably attached to the mounting opening of the cabinet so as to allow the unit to be removed and taken with a person when traveling.

The preferred cabinet embodiment also includes at least one bottom fan, and preferably two bottom fans, mounted to the bottom openings in the bottom of the cabinet. These bottom fans may be mounted so as to exhaust air from the cabinet or to blow additional air into the cabinet and upward onto the garment. In embodiments in which the bottom fans are used as exhaust fans, the bottom fans act to further increase the velocity of airflow over the garment and decrease the overall temperature within the cabinet, which is preferred when drying delicate items. However, it has been found that the use of bottom fans mounted to intake air into the cabinet produces enhanced drying action attributable to the higher temperatures that can be maintained within the cabinet when air is not exhausted and due to the turbulence created along the bottom of the garment. Accordingly, in embodiments utilizing bottom fans, it is preferred that these fans be mounted so as to intake further air. Finally, in some embodiments, the bottom fans are replaced with additional drying apparatus. In such embodiments, the additional heat and turbulent air blown over the garment acts to dry the garments even faster than in those that merely use bottom fans. However, it is recognized that embodiments without either bottom fans or additional drying apparatus are contemplated and will produce acceptable results.

It is likewise envisioned that the invention will be sold in kit form and that the kit will include at least one garment enclosure and a drying apparatus. The kit may be sold with a single garment enclosure, but preferably will be sold with a two garment enclosures made up of a cabinet and at least one substantially flexible garment bag.

Therefore, it is an aspect of the invention to provide a portable drying apparatus that blows heated air from the top down, using the wet portions of the garment to place the garment in tension to prevent the formation of wrinkles.

It is a further aspect of the invention to provide a drying apparatus that allows exhaust air to be vented directly into a room.

It is a further aspect of the invention to provide a drying apparatus that may be safely used around children.

It is a further aspect of the invention to provide a drying apparatus that dries garments effectively without the use of a 220 VAC power source.

It is a further aspect of the invention to provide a drying apparatus that may be used both with a portable garment bag and with a cabinet that is fixedly mounted within a home to form a drying system.

It is a still further aspect of the invention to provide a drying kit in which one drying apparatus may be used with multiple garment enclosures.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a diagrammatic side view of one embodiment of the drying apparatus of the present invention with the housing cut away to show the arrangement of interior components.

FIG. 2 is a diagrammatic side view of the drying apparatus of FIG. 1 with the housing intact.

FIG. 3 is a cut away side view of the preferred embodiment of the drying apparatus of the present invention.

FIG. 4 is a front view of one embodiment of the assembled kit of the present invention with the garment enclosure cut away to show a hanging garment.

FIG. 5 is a cut away front view of one embodiment of the system of the present invention in which two drying apparatus are attached to a top of a single cabinet style enclosure and in which two bottom fans are attached to the bottom of the cabinet.

FIG. 6 is a cut away front view of another embodiment of the system of the present invention in which two drying apparatus are attached to a top of a single cabinet style enclosure and in which drying apparatus are attached to the bottom of the cabinet.

### DETAILED DESCRIPTION OF THE INVENTION

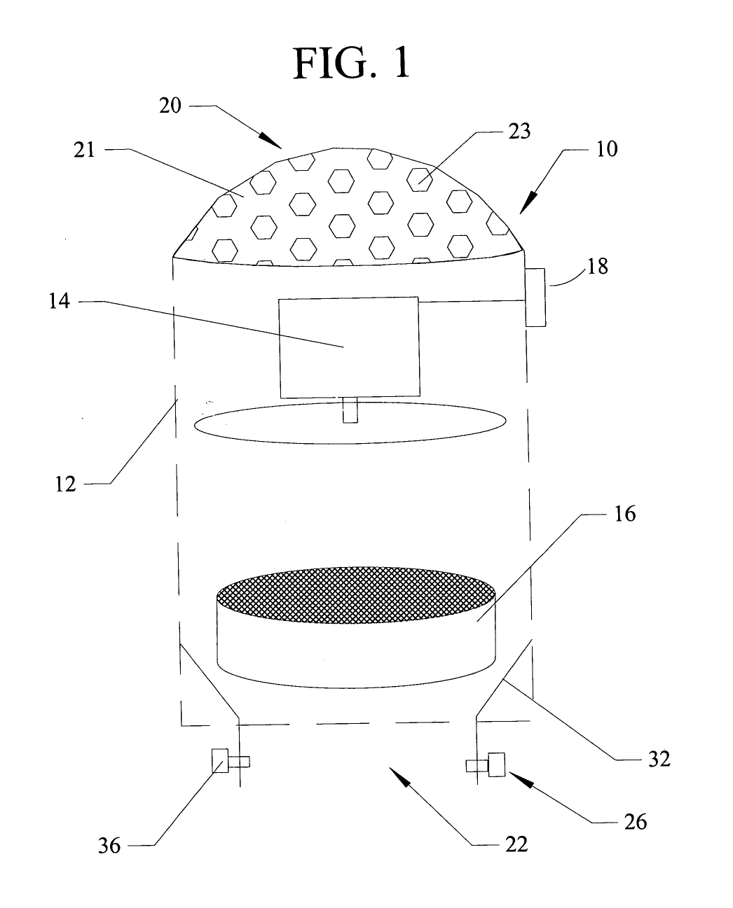

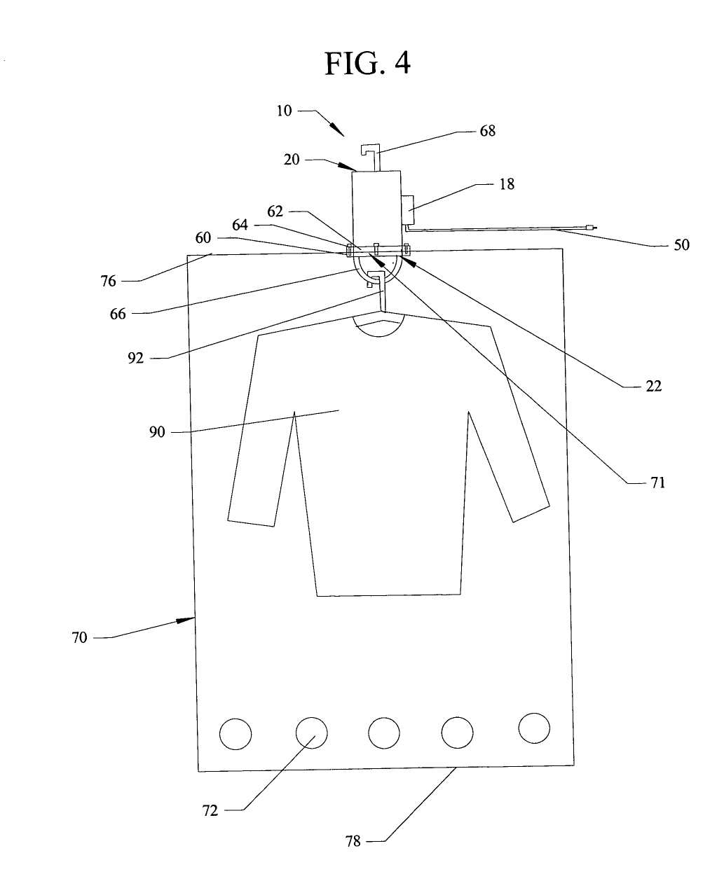

Referring first to FIG. 1, a basic embodiment of the apparatus 10 for drying and de-wrinkling an article of clothing is shown. In the basic embodiment, there is a housing 12, attachment means 26 for removably attaching the housing 12 to a garment enclosure (shown in FIG. 4) a fan 14, a heater 16 and a control unit 18.

The housing 12 is preferably constructed of a lightweight material to allow the apparatus 10 to be easily transportable. The preferred housing 12 is manufactured of sheet metal due to its low cost, ready availability and ease of manufacture. However, in other embodiments the housing 12 may be manufactured of wood to provide the unit with a “furniture” look that allows it to fit in with the décor of a non-utility type room. In still others it is manufactured of molded plastics, PVC, ABS, or other non-metallic materials commonly utilized in the manufacture of portable heaters.

The preferred housing 12 is substantially cylindrical in shape and includes an air intake 20 and an air exhaust 22. The air intake 20 allows air to enter the housing 12 and is preferably located at the top of the housing 12. The intake may include a guard 21 having single or multiple perforations 23, although it is preferred that multiple perforations 23 are used to prevent the intake of objects other than air. Similarly, the exhaust 22 may include a guard having an arrangement of one or multiple perforations; although the exhaust 22 of the embodiment of FIG. 1 is merely a single opening. It is noted that neither arrangement is preferred over the other as an exhaust having a guard made up of multiple perforations provides an added degree of protection from the user burning himself/herself, while an exhaust 22 having a single large opening reduces the pressure drop through the apparatus 10 and consequently enhances the flow of air therethrough.

The exhaust 22 allows air to exit the housing 12 and is preferably located at the base of the housing 12. In the preferred embodiment, the air intake 20 and air exhaust 22 are disposed in a straight-line relation to one another such that the air pressure drop from the air intake 20 to the air exhaust 22 is minimized. Such an arrangement is preferred as it allows a lower power fan 14 to be used. However, it is recognized that other arrangements may be utilized, provided the fan 14 is sized to accommodate the increased pressure drop created by such an arrangement.

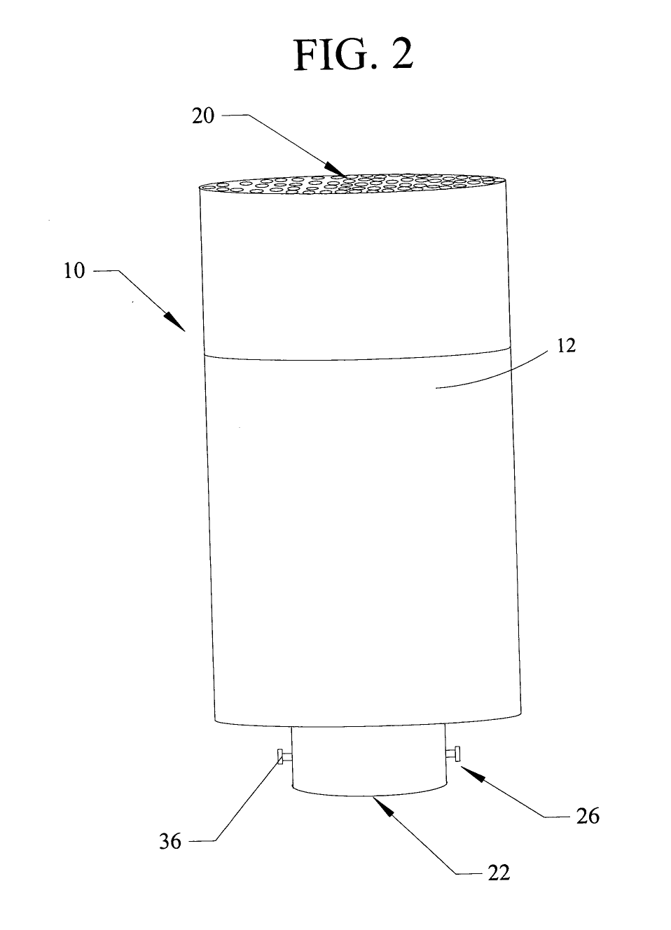

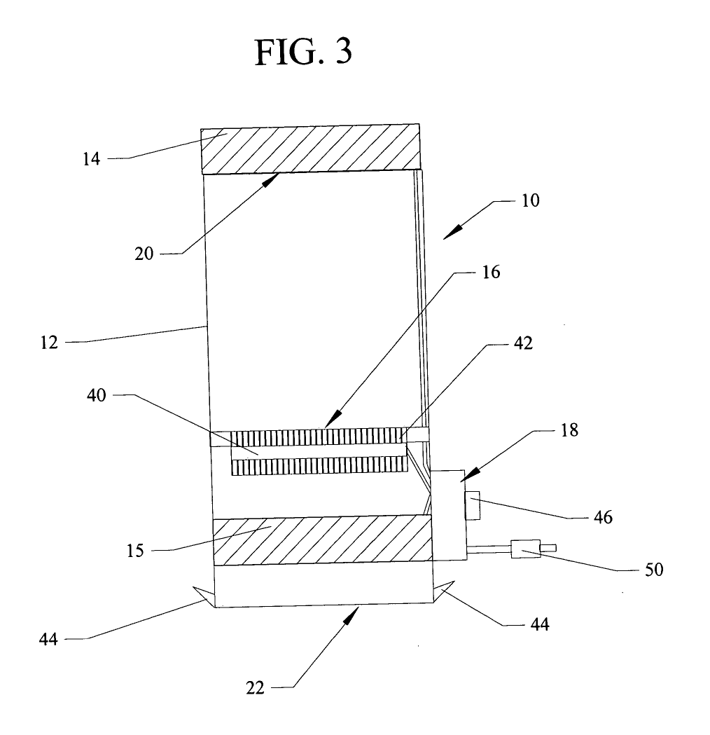

The housing 12 is sized to be portable, and the working model is four inches in diameter and twelve inches high. However, larger and smaller models based on the same process and design as the preferred embodiment have been tested and are likewise effective at solving the above mentioned problems inherent in the prior art. In the embodiments of FIGS. 1 and 2, the exhaust portion 32 of the housing 12 proximate to the air exhaust 22 is funnel shaped to reduce the diameter of the housing 12 where it mounts to the garment enclosure and act to increase the velocity of airflow through the air exhaust 22. However, as shown in FIG. 3, some embodiments include a housing 12 having a substantially constant diameter. Finally, although the drawing figures all show the apparatus 10 as having a substantially cylindrical housing 12, it is recognized that other embodiments may include a housing 12 having a different cross sections, such as square, conical or the like. Accordingly, the housing 12 should not be seen as being limited to any particular shape.

As noted above, the apparatus 10 is intended to be portable and is designed to attach to a garment enclosure, such as a garment bag or a fixed garment drying cabinet. Accordingly, the apparatus 10 includes attachment means 26 for removably attaching the housing 12 to the garment enclosure. The attachment means 26 may take many forms, provided it allows the apparatus 10 to be securely fastened to the garment enclosure. For example, in FIGS. 1 and 2, the attachment means 26 is a series of screws 36 that are dimensioned to pass through corresponding holes in the garment enclosure and with threaded openings about the periphery of the air exhaust 26 of the housing 12. In FIG. 3, the attachment means 26 is a radial groove 44 that extends about the periphery air exhaust 22 of the housing and is dimensioned to mate with the garment enclosure and hold it onto the apparatus 10 by force of gravity. In FIG. 4, the attachment means 26 takes the form of a pair of flanges 62, 64, between which the opening of the garment enclosure is sandwiched and secured using a plurality of screws 62. These specific attachment means 26 are merely examples of the many ways of performing this function, and it is recognized that those of skill in the relevant art will readily understand that other attachment means 26 may be utilized.

The fan 14 is disposed within the housing 12 and positioned to create a flow of air from the air intake 20 to the air exhaust 22. The preferred fan 14 is a duct type fan, such as those commonly used to move air through heating and ventilation ducts. The output of the fan 14 is variable, depending upon the size of the unit. In the preferred embodiment, the fan 14 will be sized to produce between 500 cubic feet per minute (CFM) to 1500 CFM of airflow and operates on a 110 VAC input. However, it is recognized that, in embodiments utilizing housings 12 of smaller diameter, fans 14 having lower output ratings may be substituted to achieve similar results. Similarly, direct current fans 14 may also be substituted provided the control means 18 likewise includes a transformer to transform the 110 VAC input into a direct current output appropriate for the chosen fan 14.

In the embodiment of FIG. 1, the fan 14 is disposed within the housing 12 proximate to the air intake 20 such that the airflow is pushed through the housing. However, other embodiments utilize fans disposed proximate to the air exhaust 22, which act to pull the airflow from the air intake 20 and heater 16 for exhaust through the air exhaust 22. As shown in FIG. 3, the preferred embodiment of the apparatus 10 includes an air intake fan 14 and an air exhaust fan 15, which act both to push the airflow and to pull the airflow through the housing 12, providing a higher volume and velocity of air over the garment to be dried. Finally, although not shown in the drawing figures, it is recognized that any number of fans and/or multiple heaters may be utilized, provided the resulting drying apparatus produces the necessary flow of heated air over the garment to be dried.

The heater 16 is disposed within the housing 12 in a position to allow heated air to exit the exhaust 22. In the embodiment of FIG. 1, the heater is positioned proximate to the air exhaust 22, while in the embodiment of FIG. 3 it is positioned in a substantially central location between the intake fan 14 and exhaust fan 15. The heater 16 is designed to heat air within the housing 12 to a suitable clothes-drying temperature; typically within a range of between 120 and 150 degrees Fahrenheit. The preferred heater 16 is a serpentine electrical-resistance heating coil 40 to which heat dissipating fins 42 are attached in a manner similar to those found in air conditioners and automotive radiators. These fins 42 are oriented to allow the airflow to pass through the heater 16 and be convectively heated by the fins. The preferred heating coil 40 dissipates between 350 and 1800 Watts of power, although coils having higher or lower power dissipation levels may be substituted depending upon the size of the housing and the volume of airflow that passes therethrough. In some embodiments, a positive temperature coefficient (PTC) heating element is substituted for the serpentine electrical coil 40. A PTC heating element is a small ceramic stone with self temperature-limiting characteristics that can be controlled to within a few degrees over a range of between approximately 100 and 535 degrees Fahrenheit. However, testing has confirmed that appropriately sized PTC heating elements act to reduce the overall flow of air through the drying apparatus and, therefore, the use of such elements is not preferred.

The control means 18 is adapted to supply and terminate power to the heater 16, the fan 14, or both simultaneously. Certain embodiments of the present invention include separate control means 18, such as a thermostat, for controlling the heater 16 and for controlling the fan 14. The preferred control means 18 simultaneously controls both the air blower 14 and the heater 16. In some embodiments, this control means 18 is merely an on/off switch that is in communication with an electrical plug 50 and allows the user to manually energize and de-energize the fan 14 and heater 16, which each operate at a constant settings. In the embodiment of FIG. 3, the control means 18 is a timer 46, which operates in a manner similar to the on/off type switch except that it automatically deenergizes the fan 14 and heater after a period of time set by the user. In still other embodiments, however, the control means 18 is an electronic device, which allows the heater 16 and fan 14 to be controlled in a number of different modes based upon user input. For example, such a control means 18 may include a user interface to allow the heater 16 to be set to a number of heat settings and/or cause the fan to be driven at varying loads depending upon the type of garment to be dried, in a manner similar to the settings on conventional tumble dryers. Those of ordinary skill in the art of dryer design will readily understand the various possible design configurations of such an electronic control means 18 and, therefore, these configurations are not specifically described herein.

As shown in FIG. 4, the kit of the present invention includes the apparatus 10 and at least one garment enclosure 70. In the embodiment of FIG. 4, the garment enclosure 70 is a substantially flexible garment bag that includes an intake opening 71 in its top edge 76 to allow the apparatus 10 to attach thereto, and at least one bottom opening 72 proximate to its bottom edge 78 to reduce the pressure within the enclosure 70 when the apparatus 10 is running and allow a substantially downward flow of air to pass over the garment 90. As shown in FIG. 4, these bottom openings 72 are disposed along the front and rear faces of the enclosure 70 to prevent water from the garment 90 from dripping on the surface below the enclosure. However, in other embodiments, the bottom openings 72 may be disposed in the bottom of the enclosure 70, or the entire bottom 70 of the enclosure may be open, forming one large bottom opening 72.

Although the garment enclosure70 of FIG. 4 is shown as a flexible garment bag, it is likewise recognized that the enclosure 70 may be a cabinet that is designed for fixed mounting within a person's home. In these embodiments, the cabinet will be similar in all respects to the cabinet shown and described in the inventor's U.S. Pat. No. 6,745,496, which is incorporated herein by reference, or it may be altered such that the top compartment of the cabinet is eliminated and replaced with an opening through which the apparatus 10 is disposed.

In the embodiment of FIG. 4, the drying apparatus 10 includes a hanger 68 extending from the housing 12 proximate to the air intake 20 to allow the apparatus 10 to be hung from a clothes-hanging pole. This hanger 68 is shown as a simple “L” shaped hanger, although it may take many forms. The embodiment of the apparatus 10 shown in FIG. 4 also includes a means 66 for attaching a garment hanger 92 to the apparatus. In this embodiment, the means 66 is a loop extending downward from the housing 12 proximate to the air exhaust 22 to allow a garment hanger 92 to be hung therefrom such that the garment 90 is placed in a position to contact air issuing from the exhaust 22. However, in other embodiments, the garment enclosure 70 itself is equipped with a means 66, such as a rod, loop, hook or the like, for attaching a garment hanger 92 in the desired orientation.

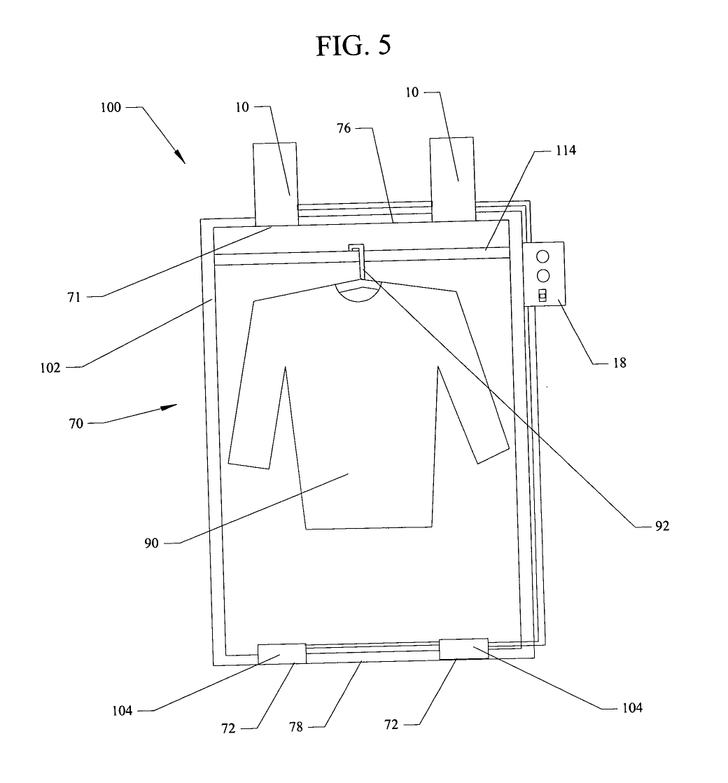

Referring now to FIG. 5, a preferred embodiment of the system 100 of the present invention is shown. The system 100 includes two drying apparatus 10 mounted to a pair of intake openings 71 the top of a fixed cabinet 102 and a pair of bottom fans 104 mounted to the a pair of bottom openings 72 in the bottom 78 thereof. These bottom fans 104 may be mounted so as to exhaust air from the cabinet 102 or to blow additional air into the cabinet 102 and upward onto the garment 90. In embodiments in which the bottom fans 104 are used as exhaust fans, the bottom fans 104 act to further increase the velocity of airflow over the garment 90 and decrease the overall temperature within the cabinet 102, which is preferred when drying delicate garments 90. However, it has been found that the use of bottom fans 104 mounted to intake air into the cabinet 102 produces enhanced drying action attributable to the higher temperatures that can be maintained within the cabinet 102 when air is not exhausted and due to the turbulence created along the bottom of the garment 90. The elimination of a dedicated exhaust opening is a counterintuitive design, as such an arrangement should create a high pressure drop that precludes sufficient air from flowing over the garment 90. However, testing has confirmed that air within the cabinet 102 is effectively exhausted through the drying apparatus 10 and bottom fans 104 at the same time that air is being blown into the cabinet. This results in airflow of approximately 140 CFM into the cabinet 102 with the temperature within the cabinet 102 being maintained at a temperature of 135 degrees Fahrenheit as opposed to airflow of 200 CFM at a cabinet temperature of 90 degrees in embodiments in which the bottom fans 104 are used as exhaust fans. Accordingly, in embodiments utilizing bottom fans 104, it is preferred that these bottom fans 104 be mounted so as to intake further air into the cabinet 102.

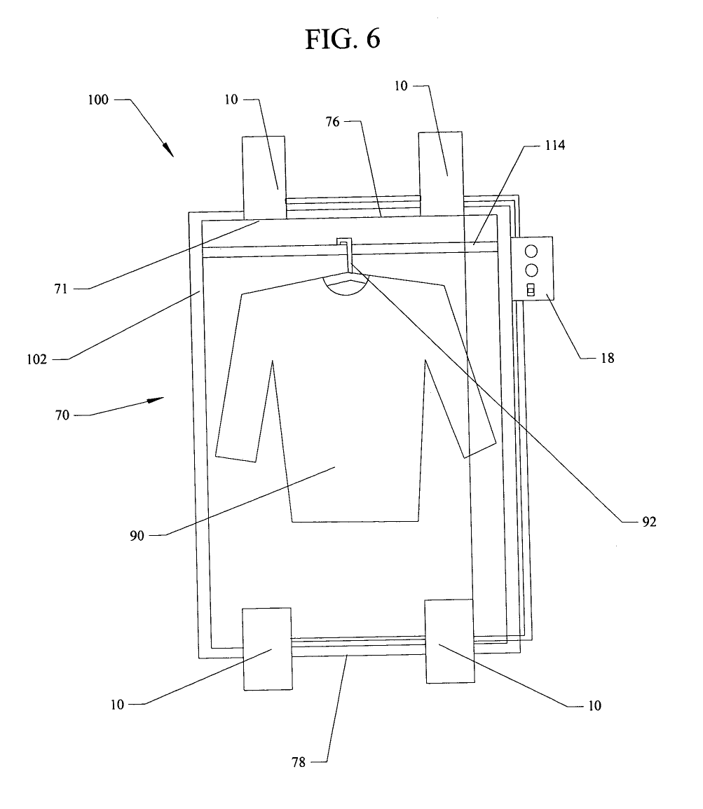

Finally, as shown in FIG. 6, some embodiments of the system replace the bottom fans 104 of FIG. 5 with additional drying apparatus 10. In such embodiments, the additional heat and turbulent air blown over the garment 90 by the bottom drying apparatus 10 acts to dry the garment 90 even faster than in those that merely use bottom fans 104.

In the embodiments of either FIG. 5 or FIG. 6, one or more of the drying apparatus 10 may be fixedly mounted to the cabinet 102, although it is preferred that at least one of the apparatus 10 be removable for enhanced portability. Further, it is recognized that other numbers of drying apparatus 10, such as three, four, five, etc., may be mounted in the top 71 or bottom 78 of the cabinet 102.

The control means 18 of the embodiments of FIGS. 5 and 6 are in communication with each of the apparatus 10 and/or with the bottom fans 104 and act to control the apparatus 10 and/or bottom fans 104. The control means 18 may take many forms, but preferably takes one of the forms described in the inventor's U.S. Pat. No. 6,745,496.

Finally, the cabinet 102 of FIGS. 5 and 6 includes a hanging rod 114 from which a garment hanger 92 may be hung during drying. However, it is recognized that hooks, or other art recognized hanging means may be utilized, or that the drying apparatus 10 mounted in the top 71 of the cabinet 102 may include hanging means such as those described with reference to FIG. 4.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

1. A drying apparatus comprising:
a housing defining an air intake and air exhaust;
at least one fan disposed within said housing and positioned to create a flow of air from said air intake to said air exhaust;
a heater disposed within said housing and positioned to heat said flow of air directed from said air intake to said air exhaust;
control means for controlling an operation of at least one of said at least one fan and said heater; and
attachment means for removably attaching said housing to a garment enclosure.

2. The apparatus as claimed in claim 1 wherein said at least one fan comprises an intake fan mounted within said housing proximate to said air intake and an exhaust fan mounted within said housing proximate to said air exhaust.

3. The apparatus as claimed in claim 1 wherein said heater comprises an electrical resistance heating coil and a plurality of thermally conductive fins disposed in heat conducting relation to said electrical resistance heating coil.

4. The apparatus as claimed in claim 2 wherein said heater comprises an electrical resistance heating coil and a plurality of thermally conductive fins disposed in heat conducting relation to said electrical resistance heating coil.

5. The apparatus as claimed in claim 1 wherein said housing has a substantially cylindrical shape.

6. The apparatus as claimed in claim 1 wherein said housing further comprises a substantially funnel shaped exhaust portion and wherein said air intake has a cross sectional area greater than a cross sectional area of said air exhaust.

7. The apparatus as claimed in claim 1 further comprising a guard attached to said air intake, said guard comprising a plurality of perforations therethrough.

8. The apparatus as claimed in claim 1 further comprising a hanger extending from said housing proximate to the air intake.

9. The apparatus as claimed in claim 1 further comprising a means for attaching a garment hanger to said apparatus.

10. A drying system comprising:
a garment enclosure comprising a top, a bottom, at least one mounting opening through said top and at least one bottom opening disposed proximate to said bottom; and
at least one drying apparatus comprising:
a housing defining an air intake and air exhaust;
at least one fan disposed within said housing and positioned to create a flow of air from said air intake to said air exhaust;
a heater disposed within said housing and positioned to heat said flow of air directed from said air intake to said air exhaust;
control means for controlling an operation of at least one of said at least one fan and said heater; and
attachment means disposed upon said housing and attached to said mounting opening of said garment enclosure.

11. The system as claimed in claim 10 wherein said at least one fan of said drying apparatus comprises an intake fan mounted within said housing proximate to said air intake and an exhaust fan mounted within said housing proximate to said air exhaust.

12. The system as claimed in claim 10 wherein said heater of said drying apparatus comprises an electrical resistance heating coil and a plurality of thermally conductive fins disposed in heat conducting relation to said electrical resistance heating coil.

13. The system as claimed in claim 11 wherein said heater of said drying apparatus comprises an electrical resistance heating coil and a plurality of thermally conductive fins disposed in heat conducting relation to said electrical resistance heating coil.

14. The system as claimed in claim 10 wherein said housing of said drying apparatus has a substantially cylindrical shape.

15. The system as claimed in claim 10 wherein said housing of said drying apparatus further comprises a substantially funnel shaped exhaust portion and wherein said air intake has a cross sectional area greater than a cross sectional area of said air exhaust.

16. The system as claimed in claim 10 wherein said drying apparatus further comprises a guard attached to said air intake, said guard comprising a plurality of perforations therethrough.

17. The system as claimed in claim 10 wherein said drying apparatus further comprises a hanger extending from said housing proximate to the air intake.

18. The system as claimed in claim 10 wherein said drying apparatus further comprises a means for attaching a garment hanger to said apparatus.

19. The system as claimed in claim 10 wherein said garment enclosure is a substantially flexible garment bag.

20. The system as claimed in claim 10 wherein said garment enclosure is a cabinet.

21. The system as claimed in claim 20 wherein said cabinet comprises at least two mounting openings through said top, wherein said at least one drying apparatus comprises at least two drying apparatus, wherein one drying apparatus is disposed within each of said mounting openings, and wherein at least one of said at least two drying apparatus is removably attached to said at least one of said mounting openings.

22. The system as claimed in claim 21 further comprising at least one bottom fan attached to said at least one bottom opening of said cabinet.

23. The system as claimed in claim 22 wherein said cabinet comprises at least two bottom openings through said bottom, wherein said at least one bottom fan comprises at least two bottom fans, and wherein one bottom fan is disposed within each of said bottom openings of said cabinet.

24. The system as claimed in claim 21 further comprising at least one bottom drying apparatus attached to said at least one bottom opening of said cabinet.

25. The system as claimed in claim 22 wherein said cabinet comprises at least two bottom openings through said bottom, wherein said at least one bottom drying apparatus comprises at least two bottom drying apparatus, and wherein one bottom apparatus is disposed within each of said bottom openings of said cabinet.

26. A kit for forming a drying system, said kit comprising:
at least one garment enclosure comprising a top, a bottom, at least one mounting opening through said top and at least one bottom opening disposed proximate to said bottom; and
a drying apparatus comprising:
a housing defining an air intake and air exhaust;
at least one fan disposed within said housing and positioned to create a flow of air from said air intake to said air exhaust;
a heater disposed within said housing and positioned to heat said flow of air directed from said air intake to said air exhaust;
control means for controlling an operation of at least one of said at least one fan and said heater; and
attachment means disposed upon said housing and dimensioned to attach to said mounting opening of said garment enclosure.

27. The kit as claimed in claim 26 wherein said at least one fan of said drying apparatus comprises an intake fan mounted within said housing proximate to said air intake and an exhaust fan mounted within said housing proximate to said air exhaust.

28. The kit as claimed in claim 26 wherein said heater of said drying apparatus comprises an electrical resistance heating coil and a plurality of thermally conductive fins disposed in heat conducting relation to said electrical resistance heating coil.

29. The kit as claimed in claim 27 wherein said heater of said drying apparatus comprises an electrical resistance heating coil and a plurality of thermally conductive fins disposed in heat conducting relation to said electrical resistance heating coil.

30. The kit as claimed in claim 26 wherein said housing of said drying apparatus has a substantially cylindrical shape.

31. The kit as claimed in claim 26 wherein said housing of said drying apparatus further comprises a substantially funnel shaped exhaust portion and wherein said air intake has a cross sectional area greater than a cross sectional area of said air exhaust.

32. The kit as claimed in claim 26 wherein said drying apparatus further comprises a guard attached to said air intake, said guard comprising a plurality of perforations therethrough.

33. The kit as claimed in claim 26 wherein said drying apparatus further comprises a hanger extending from said housing proximate to the air intake.

34. The kit as claimed in claim 26 wherein said drying apparatus further comprises a means for attaching a garment hanger to said apparatus.

35. The kit as claimed in claim 26 wherein said at least one garment enclosure is a substantially flexible garment bag.

36. The kit as claimed in claim 26 wherein said at least one garment enclosure is a cabinet.

37. The kit as claimed in claim 36 wherein said cabinet comprises at least two mounting openings through said top and wherein said at least one drying apparatus comprises at least two drying apparatus, and wherein one drying apparatus is disposed within each of said mounting openings.

38. The kit as claimed in claim 37 further comprising at least one bottom fan attached to said at least one bottom opening of said cabinet.

39. The kit as claimed in claim 38 wherein said cabinet comprises at least two bottom openings through said bottom, wherein said at least one bottom fan comprises at least two bottom fans, and wherein one bottom fan is disposed within each of said bottom openings of said cabinet.

40. The kit as claimed in claim 26 further comprising at least one bottom drying apparatus attached to said at least one bottom opening of said cabinet.

41. The system as claimed in claim 26 wherein said cabinet comprises at least two bottom openings through said bottom, wherein said at least one bottom drying apparatus comprises at least two bottom drying apparatus, and wherein one bottom apparatus is disposed within each of said bottom openings of said cabinet.

42. The kit as claimed in claim 26 wherein said at least one garment enclosure comprises at least two garment enclosures and wherein at least one of said at least two garment enclosures is a substantially flexible garment bag.

43. The kit as claimed in claim 42 wherein at least one of said at least two garment enclosures is a cabinet.
